(19) United States
(12) Patent Application Publication
(10) Pub. No.: US 2024/0112091 A1
(43) Pub. Date: Apr. 4, 2024

(54) METHODS, APPARATUSES, AND SYSTEMS FOR MULTI-PARTY COLLABORATIVE MODEL UPDATING FOR PRIVACY PROTECTION

(71) Applicant: Alipay (Hangzhou) Information Technology Co., Ltd., Hangzhou (CN)

(72) Inventor: Lingjuan Lv, Hangzhou (CN)

(73) Assignee: Alipay (Hangzhou) Information Technology Co., Ltd., Hangzhou (CN)

(21) Appl. No.: 18/535,061

(22) Filed: Dec. 11, 2023

Related U.S. Application Data
(63) Continuation of application No. PCT/CN2022/094020, filed on May 20, 2022.

(30) Foreign Application Priority Data
Jun. 11, 2021 (CN) 202110657041.8

(51) Int. Cl. G06N 20/10

(52) U.S. Cl. CPC G06N 20/10

(57) ABSTRACT

This specification disclose methods, apparatus, and systems for updating machine learning models. In one implementation, a method includes: determining, by a participant of a plurality of participants, a local gradient vector based on a local sample set and current model parameters, obtaining a perturbed gradient vector by performing random binarization processing on the local gradient vector based on a differential privacy algorithm, and sending the perturbed gradient vector to a server. The method further includes receiving a target gradient vector from the server. The target gradient vector is determined by performing binary representation on an aggregation result of aggregating a plurality of perturbed gradient vectors received from the plurality of participants. The method further includes updating, by the participant, the current model parameters based on the target gradient vector.

### CROSS-REFERENCE TO RELATED APPLICATIONS

This application is a continuation of PCT Application No. PCT/CN2022/094020, filed on May 20, 2022, which claims priority to Chinese Patent Application No. 202110657041.8, filed on Jun. 11, 2021 and each application is hereby incorporated by reference in its entirety.

### TECHNICAL FIELD

One or more embodiments of this specification relate to the field of computer technologies, and in particular, to methods, apparatuses, and systems for multi-party collaborative model updating for privacy protection.

### BACKGROUND

The emergence of federated learning revolutionizes conventional centralized machine learning, and participants can collaboratively construct more accurate models without having to upload local data.

Currently, federated learning is usually implemented by sharing model parameters or gradients between participants. However, because the model parameters or gradients are usually high-dimensional private data, problems such as large communication overheads and privacy disclosure are accompanied by conventional federated learning.

### SUMMARY

One or more embodiments of this specification describe methods, apparatuses, and systems for multi-party collaborative model updating for privacy protection, which can effectively reduce communication resource consumption caused by multi-party collaborative modeling, and play a privacy protection role.

According to a first aspect, a method for multi-party collaborative model updating for privacy protection is provided, including: Each participant i determines a corresponding local gradient vector based on a local sample set and current model parameters; each participant i performs random binarization processing on elements in the local gradient vector by using a randomized algorithm that satisfies differential privacy, to obtain a perturbed gradient vector; each participant i sends the determined perturbed gradient vector to a server, the server aggregates n perturbed gradient vectors sent by n participants, and performs binary representation on elements in a current aggregation result based on plus-minus signs of the elements, to obtain a target gradient vector; each participant i receives the target gradient vector from the server, and updates the current model parameters based on the target gradient vector for a next round of iteration; and after the plurality of rounds of iterations, each participant i uses the current model parameters obtained by the participant i as a service prediction model that is updated by the participant i in collaboration with other participants.

According to a second aspect, a method for multi-party collaborative model updating for privacy protection is provided, including: A corresponding local gradient vector is determined based on a local sample set and current model parameters; random binarization processing is performed on elements in the local gradient vector by using a randomized algorithm that satisfies differential privacy, to obtain a perturbed gradient vector, the perturbed gradient vector is sent to a server; a target gradient vector is received from the server, where the target gradient vector is obtained after the server aggregates n perturbed gradient vectors sent by n participants, and then performs binary representation on elements in a current aggregation result based on plus-minus signs of the elements; the current model parameters are updated based on the target gradient vector for a next round of iteration; and after the plurality of rounds of iterations, the current model parameters obtained by the participant i is used as a service prediction model that is updated by the participant i in collaboration with other participants.

According to a third aspect, a system for multi-party collaborative model updating for privacy protection is provided, including: Each participant i is configured to determine a corresponding local gradient vector based on a local sample set and current model parameters; each participant i is further configured to perform random binarization processing on elements in the local gradient vector by using a randomized algorithm that satisfies differential privacy, to obtain a perturbed gradient vector, each participant i is further configured to send the determined perturbed gradient vector to a server, the server is configured to aggregate n perturbed gradient vectors sent by n participants, and perform binary representation on elements in a current aggregation result based on plus-minus signs of the elements, to obtain a target gradient vector, each participant i is further configured to receive the target gradient vector from the server, and update the current model parameters based on the target gradient vector for a next round of iteration; and after the plurality of rounds of iterations, each participant i is further configured to use the current model parameters obtained by the participant i as a service prediction model that is updated by the participant i in collaboration with other participants.

According to a fourth aspect, an apparatus for multi-party collaborative model updating for privacy protection is provided, including: a determining unit, configured to determine a corresponding local gradient vector based on a local sample set and current model parameters; a processing unit, configured to perform random binarization processing on elements in the local gradient vector by using a randomized algorithm that satisfies differential privacy, to obtain a perturbed gradient vector, a sending unit, configured to send the perturbed gradient vector to a server; a receiving unit, configured to receive a target gradient vector from the server, where the target gradient vector is obtained after the server aggregates n perturbed gradient vectors sent by n participants, and then performs binary representation on elements in a current aggregation result based on plus-minus signs of the elements; and an updating unit, configured to update the current model parameters based on the target gradient vector for a next round of iteration, where after the plurality of rounds of iterations, the determining unit is further configured to use the current model parameters obtained by the participant i as a service prediction model that is updated by the participant i in collaboration with other participants.

According to a fifth aspect, a computer storage medium is provided. The computer storage medium stores a computer program, and when the computer program is executed in a computer, the computer is enabled to perform the method according to the first aspect or the second aspect.

According to a sixth aspect, a computing device is provided, including a memory and a processor. The memory stores executable code, and the processor executes the executable code to implement the method according to the first aspect or the second aspect.

According to the methods, apparatuses, and systems for multi-party collaborative model updating for privacy protection provided in one or more embodiments of this specification, the participants send only perturbed gradient vectors to the server. Because the perturbed gradient vector is obtained by performing perturbation on the original local gradient vector by using the randomized algorithm that satisfies differential privacy, validity and privacy protection of data of the participants can be balanced in this solution. In addition, the server delivers only binary representations of the elements in the current aggregation result to the participants, which can resolve a problem in the conventional technology that high-dimensional model parameters or gradients need to be delivered to the participants to occupy communication resources.

### BRIEF DESCRIPTION OF DRAWINGS

To describe the technical solutions in embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is a schematic diagram illustrating federated learning based on central differential privacy;

FIG. 2 is a schematic diagram illustrating federated learning based on local differential privacy;

FIG. 3 is a schematic diagram illustrating an implementation scenario, according to one or more embodiments of this specification;

FIG. 4 is an interaction diagram illustrating a method for multi-party collaborative model updating for privacy protection, according to one or more embodiments of this specification;

FIG. 5 is a schematic diagram illustrating a system for multi-party collaborative model updating for privacy protection, according to one or more embodiments of this specification; and

FIG. 6 is a schematic diagram illustrating an apparatus for multi-party collaborative model updating for privacy protection, according to one or more embodiments of this specification.

### DESCRIPTION OF EMBODIMENTS

The following describes the solutions provided in this specification with reference to the accompanying drawings.

As described above, conventional federated learning is implemented by sharing model parameters or gradients between participants. Mainstream solutions are mainly divided into two types: The first type is federated learning based on central differential privacy (CDP), and the second type is federated learning based on local differential privacy (LDP). The following describes the two methods with reference to the accompanying drawings.

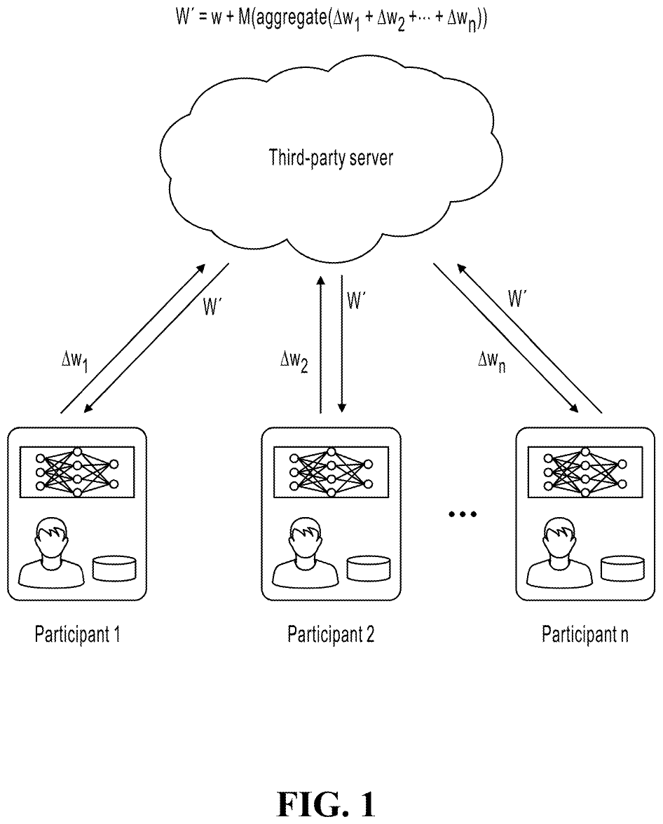

FIG. 1 is a schematic diagram illustrating federated learning based on central differential privacy. In FIG. 1, first, participants upload their respective model gradients: Δw1, Δw2, . . . , and Δwn to a trusted third-party server (referred to as a server below). Then, the server aggregates the model gradients uploaded by the participants: aggregate (Δw1+Δw2+ . . . +Δwn), and adds noise to an aggregated model gradient by using a differential privacy mechanism M: M(aggregate ( . . . )). Finally, the server delivers a model gradient w′ obtained after the noise is added to the participants, so that the participants update local models of the participants based on the model gradient w′. However, because currently trusted third parties are rare in an actual scenario and are prone to be attacked by eavesdroppers, applicability of the method is poor. In addition, because a quantity of dimensions of the model gradient is usually high, gradient interaction between the server and the participants causes high communication overheads.

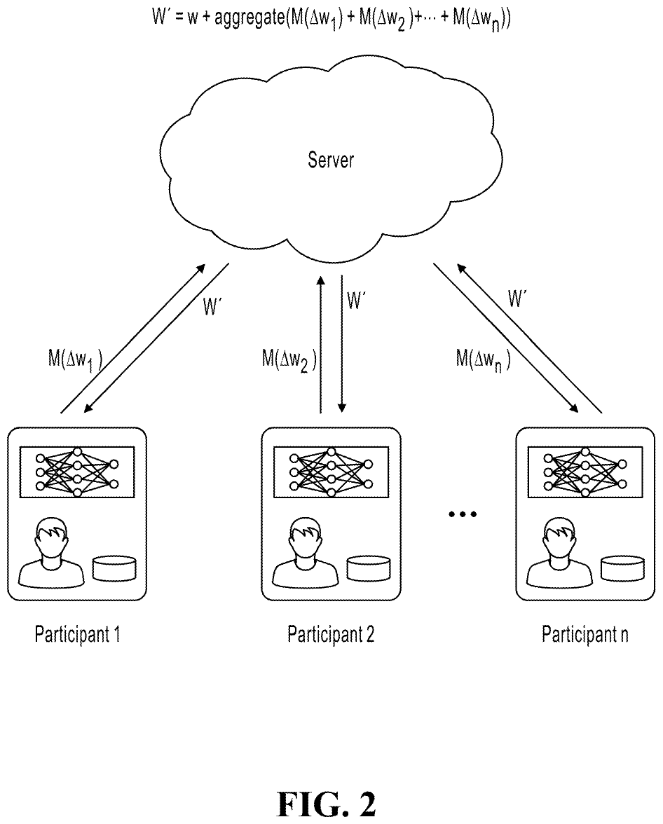

FIG. 2 is a schematic diagram illustrating federated learning based on local differential privacy. In FIG. 2, before uploading model gradients, participants first perform local differential privacy on the model gradients of the participants by using a differential privacy mechanism M, and then upload the model gradients (M(Δw1), M(Δw2), . . . , and M(Δwn)) that undergo local differential privacy to a server. Finally, the server aggregates the model gradients of the participants that undergo local differential privacy: aggregate (M(Δw1)+M(Δw2)+ . . . +M(Δwn)), and delivers an aggregated model gradient w′ to the participants, so that the participants updates local models of the participants based on the model gradient w′. In this solution, large communication overheads are also caused.

It can be seen that the above two types of federated learning cause large communication overheads. Based on this, the present application proposes a method for multi-party collaborative model construction for privacy protection. A server needs to interact with participants twice. One interaction is that the participants upload perturbed gradient vectors respectively obtained by the participants by perturbing corresponding local gradient vectors, so as to implement local differential privacy (LDP) processing on the local gradient vectors of the participants. Another interaction is that the server delivers binary representations of elements in a result of aggregating n perturbed gradient vectors to the participants. A data amount of the perturbed gradient vectors and the binary representations of the elements is far less than that in a real model gradient of high precision, so that the solution in the present application can effectively reduce communication resource consumption caused by multi-party collaborative modeling.

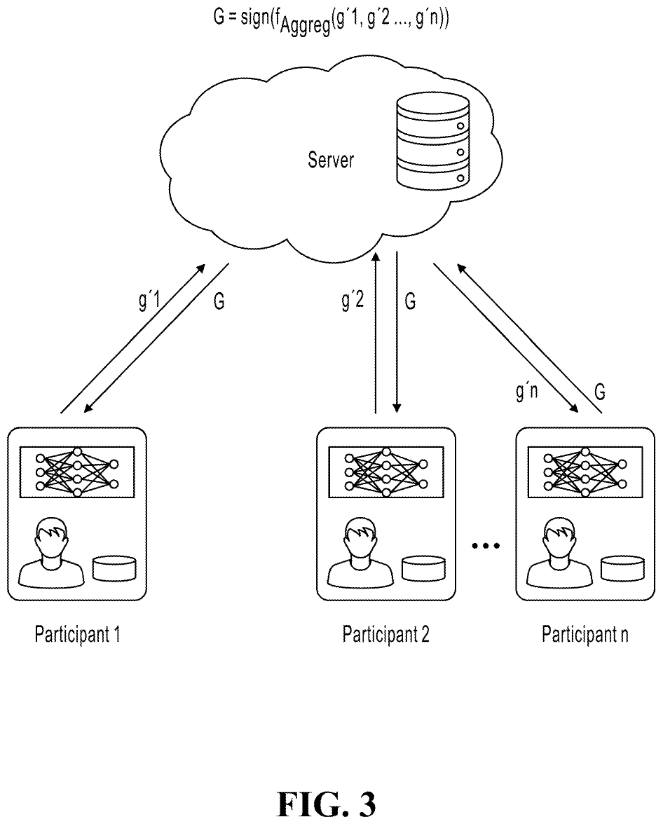

FIG. 3 is a schematic diagram illustrating an implementation scenario, according to one or more embodiments of this specification. In FIG. 3, a scenario of multi-party collaborative model updating relates to a server and n participants, and n is a positive integer. Each participant can be implemented as any device, platform, server, or device cluster that has computing and processing capabilities. In a specific example, each participant can be an institution having a set of samples of different scales. It is worthwhile to note that, the server and the participants need to collaboratively update local models of the participants while protecting data privacy. The model here can be a service prediction model used to execute a prediction task for a service object. The service object can be, for example, a picture, audio, or text.

In FIG. 3, the participants respectively maintain the same current model parameters w[t] locally and have different local sample sets D. Specifically, the method in the present application includes a plurality of rounds of iterations. In a t^{th} round of iteration, each participant i determines a corresponding local gradient vector gᵢ based on the local sample set D; and the current model parameters w[t], and performs random binarization processing on elements in the local gradient vector gᵢ by using a randomized algorithm that satisfies differential privacy, to obtain a perturbed gradient vector g′ᵢ. Then, each participant i sends the determined perturbed gradient vector g′ᵢ to the server. The server aggregates n perturbed gradient vectors sent by the n participants, and performs binary representation on elements in a current aggregation result based on plus-minus signs of the elements, to obtain a target gradient vector G. Each participant i receives the target gradient vector G from the server, and updates the current model parameters w[t] based on the target gradient vector to obtain w[t+1] for a next round of iteration.

After the plurality of rounds of iterations, each participant i uses the current model parameters obtained by the participant i as a service prediction model that is updated by the participant i in collaboration with other participants.

The following uses the implementation scenario shown in FIG. 3 as an example to describe the method for multi-party collaborative model updating for privacy protection provided in this specification.

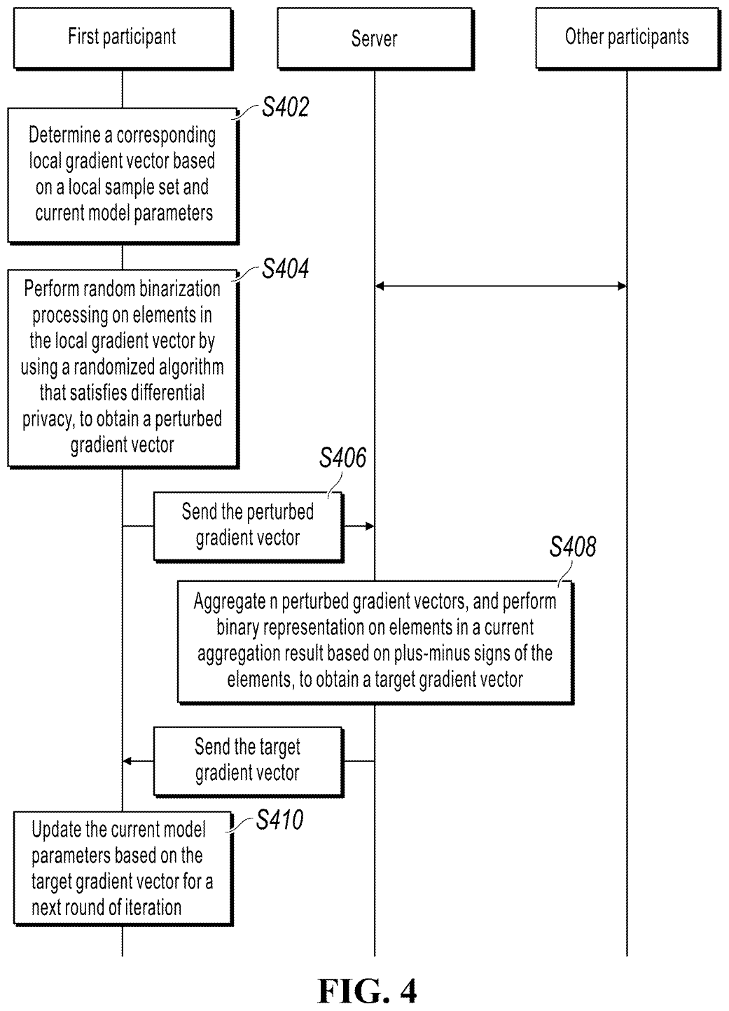

FIG. 4 is an interaction diagram illustrating a method for multi-party collaborative model updating for privacy protection, according to one or more embodiments of this specification. It is worthwhile to note that the method relates to a plurality of rounds of iterations. FIG. 4 shows interaction steps included in a t^{th} round of iteration (t is a positive integer). In addition, because processes of interaction between participants in the t^{th} round of iteration and a server are similar, FIG. 4 mainly shows steps of interaction between any participant (referred to as a first participant for ease of description) in the t^{th} round of iteration and the server. For steps of interaction between other participants in the round of iteration and the server, reference can be made to the steps of interaction between the first participant and the server. It can be understood that, the interaction steps shown in the figure can be repeatedly performed to perform a plurality of rounds of iterative update on models respectively maintained by the participants, and models obtained in last iterative update are used as models respectively used by the participants finally. As shown in FIG. 4, the method can include the following steps: Step 402: Each participant i determines a corresponding local gradient vector based on a local sample set and current model parameters.

Using any participant as an example, samples in the local sample set maintained by the participant can include any one of the following: pictures, text, audio, etc.

In addition, the current model parameters can be model parameters in a neural network model.

It is worthwhile to note that, when the t^{th} round of iteration is the first round of iteration, the current model parameters can be obtained in the following method: The server initializes the neural network model before the plurality of rounds of iterations start, and then delivers or provides initialized model parameters to the participants, so that the participants can use the initialized model parameters as the current model parameters of the participants. Certainly, in actual application, a model structure (for example, a type of model used, a quantity of layers of the model, and a quantity of neurons at each layer) can be agreed on by the participants first, and then same initialization is performed to obtain the current model parameters of the participants.

When the t^{th} round of iteration is not the first round of iteration, the current model parameters can be obtained through updating in a (t−1)^{th} round of iteration.

For determining of the local gradient vector, references can be made to the existing technology. For example, a prediction result can be first determined based on the local sample set and the current model parameters, and then a prediction loss is determined based on the prediction result and sample labels. Finally, the local gradient vector corresponding to the current model parameters is determined based on the prediction loss by using a back propagation method.

Step 404: Each participant i performs random binarization processing on elements in the local gradient vector by using a randomized algorithm that satisfies differential privacy, to obtain a perturbed gradient vector.

The random binarization processing process in step 404 is intended to randomly convert values of the elements in the local gradient vector to −1 or 1 based on a differential privacy need. The randomized algorithm can be specifically implemented in a plurality of methods. In a plurality of embodiments, for any particular element, a larger value corresponding to the element indicates a larger probability of conversion to 1, and a smaller value corresponds to the element indicates a larger probability of conversion to −1.

In other words, the perturbed gradient vector described in the embodiments of this specification is only a low-precision vector (including only −1 and 1) used to reflect overall characteristics of the local gradient vector, and communication resources occupied by the perturbed gradient vector in a transmission process are far less than those occupied by a high-precision local gradient vector.

Specifically, any element i in the local gradient vector is referred to as a first element for simplicity. The random binarization processing process for the first element in step 404 includes: converting the value of the first element to 1 by using a first probability (Pr), and converting the value of the first element to −1 by using a second probability (1−Pr), where the first probability is positively correlated with the value of the first element.

In an example, a method for determining the first probability can include: adding a noise value to the value of the first element; and determining the first probability based on the value of the first element obtained after the noise value is added and by using a cumulative distribution function with Gaussian distribution.

In an example, the random binarization processing process can be represented as:

$${dpsign ( {g}_{i}^{( t )} )}_{j} = \{ \begin{matrix}1 , & with probability Φ ( \frac{{( {g}_{i}^{( t )} )}_{j}}{z} ) \\ - 1 , & with probability 1 - Φ ( \frac{{( {g}_{i}^{( t )} )}_{j}}{z} )\end{matrix} \qquad ( Formula 1 )$$

where t represents the t^{th} round of iteration; i represents the participant i, where 1≤i≤n; j represents a j^{th} vector element; (gᵢ^{(t)})ⱼ represents a j^{th} element in the local gradient vector of the participant i in the t^{th} round; Z represents the noise value; dpsign(gᵢ^{(t)})ⱼ represents a j^{th} element in the perturbed gradient vector of the participant i in the t^{th} round; and (Φ( ) is the cumulative distribution function with the Gaussian distribution.

It is worthwhile to note that, the noise value in the embodiments of this specification can be obtained through random sampling from Gaussian distribution whose expected value is 0 and variance is σ².

In one or more embodiments, a is determined based on at least products of global sensitivity of the local gradient vector and proportions of two differential privacy parameters. The global sensitivity can be a parameter related to data distribution, complexity, etc. of the local sample set, and the two differential privacy parameters are respectively (ε, δ)—a privacy budget ε and a relaxation term δ of a differential privacy algorithm (that is, a probability of exposing real private data).

In an example, a formula for calculating a can be specifically represented as:

σ=Δ\sqrt{2 log(1.25/δ)}/ε (Formula 2)
where σ represents a standard deviation of the Gaussian distribution, Δ represents the global sensitivity of the local gradient vector, ε and δ respectively represent (ε, δ)—two privacy parameters of a differential privacy algorithm, and specifically, a value range of ε can be greater than or equal to 0, and a value range of δ can be [0, 1].

In other embodiments, σ can be set based on the following constraint condition: a third probability calculated by using the cumulative distribution function for a maximum boundary value of the function determined based on at least a is close to a fourth probability calculated by using the cumulative distribution function for a minimum boundary value of the function determined based on at least σ.

The maximum boundary value of the function can be a difference between a first proportion determined based on the global sensitivity and σ and a second proportion determined based on a product of a privacy budget ε and σ and the global sensitivity. The minimum boundary value of the function can be a difference between an opposite number of the first proportion and the second proportion.

In a specific example, the constraint condition can be represented as:

$$Φ ( \frac{Δ}{2 σ} - \frac{ϵ σ}{Δ} ) - {e}^{ϵ} Φ ( - \frac{Δ}{2 σ} - \frac{ϵ σ}{Δ} ) \leq δ \qquad ( Formula 3 )$$

where a represents the standard deviation of the Gaussian distribution, Δ represents the global sensitivity of the local gradient vector, ε and δ respectively represent (ε, δ)—two privacy parameters (that is, a privacy budget ε and a relaxation term δ) of the differential privacy algorithm, and (Φ( ) is the cumulative distribution function with the Gaussian distribution.

In Formula 3, an upper boundary value of the function is the difference between the first proportion

$$\frac{Δ}{2 σ}$$

and the second proportion

$$\frac{ϵ σ}{Δ} ,$$

and a lower boundary value of the function is a difference between the opposite number

$$\frac{Δ}{2 σ}$$

of the first proportion and the second proportion

$$\frac{ϵ σ}{Δ} .$$

It is worthwhile to note that, a smaller privacy budget ε in Formula 3 means that a probability obtained through calculation for the maximum boundary value of the function is close to a probability obtained through calculation for the minimum boundary value of the function, so that a degree of privacy protection is higher.

It should be understood that, in other examples, other forms of first proportions and second proportions can be used to obtain other forms of constraint conditions, provided that the noise value sampled from the Gaussian distribution defined by a in the constraint condition satisfies differential privacy need.

Step 406: Each participant i sends the determined perturbed gradient vector to the server.

It is worthwhile to note that, the perturbed gradient vector corresponding to each participant i is obtained by using the randomized algorithm that satisfies differential privacy, so that privacy of data of the participants can be protected, and availability can also be ensured. In addition, because the perturbed gradient vector is a low-precision vector used to reflect the overall characteristics of the local gradient vector, communication resources can be greatly reduced.

Step 408: The server aggregates n perturbed gradient vectors sent by the n participants, and performs binary representation on elements in a current aggregation result based on plus-minus signs of the elements, to obtain a target gradient vector.

For example, the server can perform averaging or weighted averaging on the n perturbed gradient vectors sent by the n participants to obtain the current aggregation result.

For the binary representation process, in an example, binary representation can be directly performed on the elements in the current aggregation result based on the plus-minus signs of the elements by using a sign function. The target gradient vector here can be a low-precision vector (including only −1 and 1) used to reflect overall characteristics of the current aggregation result, and communication resources occupied by the target gradient vector in a transmission process are usually small.

In an example, the binary representation process can be specifically represented as follows:

$${G}^{( t )} = sign ( \frac{1}{n} {\sum }_{i = 1}^{n} dpsign ( {g}_{i}^{( t )} ) ) \qquad ( Formula 4 )$$

where t represents the t^{th} round of iteration, n represents a quantity of parameter parties, gᵢ^{(t)} represents the local gradient vector of the participant i in the t^{th} round, dpsign(gᵢ^{(t)}) represents the perturbed gradient vector of the participant i in the t^{th} round, sign( ) represents the sign function, and G^{(t)} represents the target gradient vector in the t^{th} round.

In another example, a current error compensation vector can be first superimposed on the current aggregation result to obtain a superimposition result, and then binary representation is performed on elements in the superimposition result based on plus-minus signs of the elements by using the sign function.

The current error compensation vector is obtained by superimposing, on an error compensation vector in a previous round, a difference between an aggregation result in the previous round and a binary representation result (that is, the target gradient vector in the previous round) corresponding to the aggregation result in the previous round.

In an example, the binary representation process can be specifically represented as follows:

$${G}^{( t )} = sign ( \frac{1}{n} {\sum }_{i = 1}^{n} dpsign ( {g}_{i}^{( t )} ) + {e}^{( t )} ) \qquad ( Formula 5 )$$

where meanings of t, n, gᵢ^{(t)}, dpsign(gᵢ^{(t)}), sign( ), and G^{(t)} are the same as those described above, e^{(t)} represents an error compensation vector in the t^{th} round, and a formula for calculating the error compensation vector can be as follows:

$${e}^{( t )} = λ * {e}^{( t - 1 )} + ( 1 - λ ) * [ \frac{1}{n} {\sum }_{i = 1}^{n} dpsign ( {g}_{i}^{( t - 1 )} ) - \frac{1}{n} {G}^{( t - 1 )} ] \qquad ( Formula 6 )$$

where t and t−1 respectively represent the t^{th} round of iteration and the (t−1)^{th} round of iteration, n represents a quantity of parameter parties, e^{(t-1)} represents an error compensation vector in the (t−1)^{th} round,

$${\sum }_{i = 1}^{n} dpsign ( {g}_{i}^{( t - 1 )} )$$

represents a binary representation result (that is, a target gradient vector in the (t−1)^{th} round) corresponding to the aggregation result in the (t−1)^{th} round, e^{(t)} represents the error compensation vector in the t^{th} round, and λ represents an error attenuation rate.

In this example, the current error compensation vector is superimposed on the current aggregation result, so that error compensation can be performed on the current aggregation result, thereby improving accuracy of a binary representation result, and further improving precision of a constructed service prediction model.

Step 410: Each participant i receives the target gradient vector from the server, and updates the current model parameters based on the target gradient vector for a next round of iteration.

For example, a product of the target gradient vector and a learning step can be subtracted from the current model parameters to obtain updated current model parameters.

It is worthwhile to note that, in the embodiments of this specification, step 402 to step 410 are repeatedly performed a plurality of times, so that a plurality of rounds of iterative update can be performed on the current model parameters respectively maintained by the participants In addition, the current model parameters used in each iteration are model parameters updated in a previous round. A termination condition of the iteration can be that a quantity of iterations reaches a predetermined quantity of rounds or model parameters converge.

After the plurality of rounds of iterations, each participant i uses the current model parameters obtained by the participant i as a service prediction model that is updated by the participant i in collaboration with other participants.

Using any participant i as an example, when the samples in the local sample set of the participant i are pictures, the service prediction model that is updated by the participant i in collaboration with other participants can be a picture recognition model; when the samples in the local sample set of the participant i are audio, the service prediction model that is updated by the participant i in collaboration with other participants can be an audio recognition model; or when the samples in the local sample set of the participant i are text, the service prediction model that is updated by the participant i in collaboration with other participants can be a text recognition model.

In conclusion, in the embodiments of the present application, the participants send only perturbed gradient vectors to the server. Because the perturbed gradient vector is obtained by performing perturbation on the original local gradient vector by using the randomized algorithm that satisfies differential privacy, validity and privacy protection of data of the participants can be balanced in this solution. In addition, the server delivers only binary representations of the elements in the current aggregation result to the participant. A data amount of the perturbed gradient vectors and the binary representations is far less than that in a real model gradient of high precision, so that the solution in the present application can effectively reduce communication resource consumption caused by multi-party collaborative modeling.

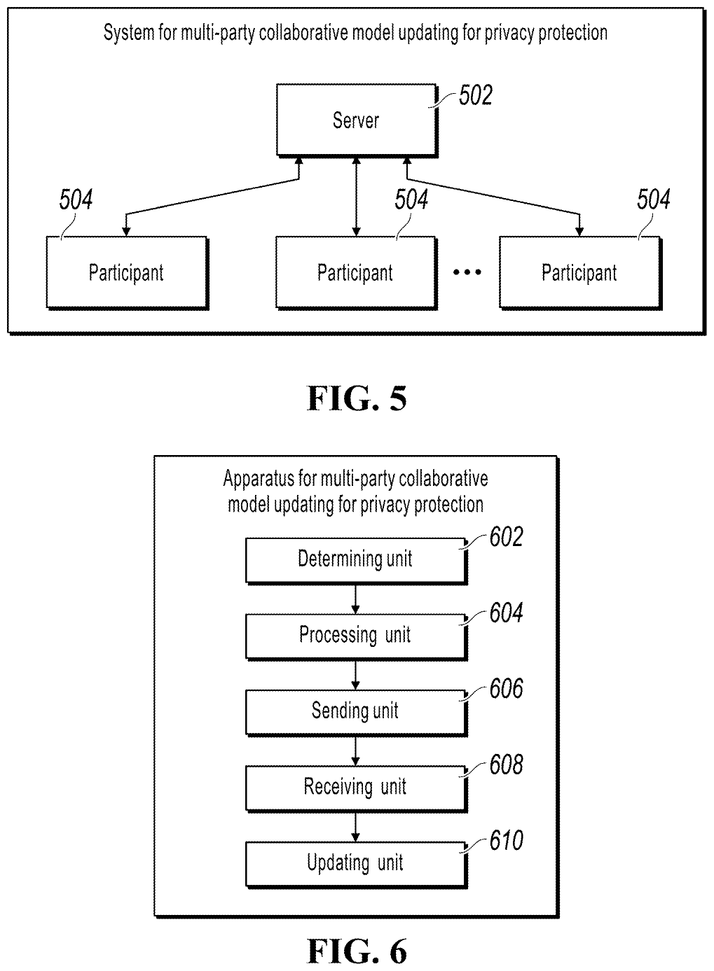

Corresponding to the above method for multi-party collaborative model updating for privacy protection, one or more embodiments of this specification further provide a system for multi-party collaborative model updating for privacy protection. As shown in FIG. 5, the system includes a server 502 and n participants 504.

Each participant 504 is configured to determine a corresponding local gradient vector based on a local sample set and current model parameters.

Each participant 504 is further configured to perform random binarization processing on elements in the local gradient vector by using a randomized algorithm that satisfies differential privacy, to obtain a perturbed gradient vector.

The local gradient vector includes a first element, and each participant 504 is specifically configured to determine a first probability based on a value of the first element, where the first probability is positively correlated with the value of the first element; and convert the value of the first element to 1 by using the first probability, and convert the value of the first element to −1 by using a second probability, where a sum of the first probability and the second probability is 1.

Each participant 504 is further specifically configured to add a noise value to the value of the first element, and determine the first probability based on the value of the first element obtained after the noise value is added and by using a cumulative distribution function with Gaussian distribution.

In an example, the noise value can be obtained through random sampling from Gaussian distribution whose expected value is 0 and variance is σ², and a here is determined based on at least products of global sensitivity and proportions of two differential privacy parameters. The two differential privacy parameters here are a privacy budget ε and a relaxation term δ.

In another example, the noise value is obtained through random sampling from Gaussian distribution whose expected value is 0 and variance is σ², and a here satisfies the following constraint condition: a third probability calculated by using the cumulative distribution function for a maximum boundary value of the function determined based on at least σ is close to a fourth probability calculated by using the cumulative distribution function for a minimum boundary value of the function determined based on at least σ.

The maximum boundary value of the function is a difference between a first proportion determined based on global sensitivity and σ and a second proportion determined based on a product of a privacy budget e and a and the global sensitivity, and the minimum boundary value of the function is a difference between an opposite number of the first proportion and the second proportion.

Each participant 504 is further configured to send the determined perturbed gradient vector to the server.

The server 502 is configured to aggregate n perturbed gradient vectors sent by n participants, and perform binary representation on elements in a current aggregation result based on plus-minus signs of the elements, to obtain a target gradient vector.

In an example, the server 502 is specifically configured to perform binary representation on the elements in the current aggregation result based on the plus-minus signs of the elements by using a sign function.

In another example, the server 502 is further specifically configured to superimpose a current error compensation vector on the current aggregation result to obtain a superimposition result, and perform binary representation on elements in the superimposition result based on plus-minus signs of the elements by using a sign function. The current error compensation vector is obtained by superimposing, on an error compensation vector in a previous round, a difference between an aggregation result in the previous round and a binary representation result corresponding to the aggregation result in the previous round.

Each participant 504 is further configured to receive the target gradient vector from the server 502, and update the current model parameters based on the target gradient vector for a next round of iteration.

After a plurality of rounds of iterations, each participant 504 is further configured to use the current model parameters obtained by the participant i as a service prediction model that is updated by the participant i in collaboration with other participants.

Samples in the local sample set of any participant i are pictures, and the service prediction model that is updated by the participant i in collaboration with other participants is a picture recognition model; or samples in the local sample set of any participant i are audio, and the service prediction model that is updated by the participant i in collaboration with other participants is an audio recognition model; or samples in the local sample set of any participant i are text, and the service prediction model that is updated by the participant i in collaboration with other participants is a text recognition model.

The functions of the functional modules of the system in the previously described embodiments of this specification can be implemented by using the steps in the previously described method embodiments. Therefore, a specific working process of the system provided in one or more embodiments of this specification is omitted here for simplicity.

The system for multi-party collaborative model updating for privacy protection provided in one or more embodiments of this specification can effectively reduce communication resource consumption caused by multi-party collaborative modeling, and play a privacy protection role.

Corresponding to the above method for multi-party collaborative model updating for privacy protection, one or more embodiments of this specification further provide an apparatus for multi-party collaborative model updating for privacy protection. The multi-party here includes a server and n participants. The apparatus is disposed in any participant i in the n participants and is configured to perform a plurality of rounds of iterations. As shown in FIG. 6, the apparatus performs any t^{th} round of iteration by using the following units included in the apparatus: a determining unit 602, configured to determine a corresponding local gradient vector based on a local sample set and current model parameters; a processing unit 604, configured to perform random binarization processing on elements in the local gradient vector by using a randomized algorithm that satisfies differential privacy, to obtain a perturbed gradient vector, a sending unit 606, configured to send the perturbed gradient vector to the server, a receiving unit 608, configured to receive a target gradient vector from the server, where the target gradient vector is obtained after the server aggregates n perturbed gradient vectors sent by the n participants, and then performs binary representation on elements in a current aggregation result based on plus-minus signs of the elements; and an updating unit 610, configured to update the current model parameters based on the target gradient vector for a next round of iteration.

After the plurality of rounds of iterations, the determining unit 602 is further configured to use the current model parameters obtained by the participant i as a service prediction model that is updated by the participant i in collaboration with other participants.

The functions of the functional modules of the apparatus in the previous embodiments of this specification can be implemented by using the steps in the previous method embodiments. Therefore, a specific working process of the apparatus provided in one or more embodiments of this specification is omitted here for simplicity.

The apparatus for multi-party collaborative model updating for privacy protection provided in one or more embodiments of this specification can effectively reduce communication resource consumption caused by multi-party collaborative modeling, and play a privacy protection role.

According to one or more embodiments of another aspect, a computer-readable storage medium is further provided. The computer-readable storage medium stores a computer program, and when the computer program is executed in a computer, the computer is enabled to perform the method described with reference to FIG. 4.

According to one or more embodiments of still another aspect, a computing device is further provided, including a memory and a processor. The memory stores executable code, and the processor executes the executable code to implement the method described with reference to FIG. 4.

The embodiments in this specification are described in a progressive way. For same or similar parts of the embodiments, mutual references can be made to the embodiments. Each embodiment focuses on a difference from other embodiments. In particular, the apparatus embodiments are basically similar to the method embodiments, and therefore are described briefly. For related parts, references can be made to related descriptions in the method embodiments.

The methods or the algorithm steps described in the disclosed content of this specification can be implemented by hardware, or can be implemented by executing software instructions by a processor. The software instructions can include corresponding software modules. The software modules can be stored in a RAM memory, a flash memory, a ROM memory, an EPROM memory, an EEPROM memory, a register, a hard disk, a removable hard disk, a CD-ROM, or any other form of storage medium known in the art. An example storage medium is coupled to a processor such that the processor can read information from the storage medium and can write information into the storage medium. Certainly, the storage medium can alternatively be a component of the processor. The processor and the storage medium can be located in an ASIC. In addition, the ASIC can be located in a server. Certainly, the processor and the storage medium can alternatively exist in the server as discrete components.

A person skilled in the art should be aware that, in the previously described one or more examples, functions described in the present application can be implemented by hardware, software, firmware, or any combination thereof. When implemented by software, these functions can be stored in a computer-readable medium or transmitted as one or more instructions or code on a computer-readable medium. The computer-readable medium includes a computer storage medium and a communication medium. The communication medium includes any medium that facilitates transmission of a computer program from one place to another. The storage medium can be any usable medium accessible to a general-purpose or special-purpose computer.

Specific embodiments of this specification are described above. Other embodiments fall within the scope of the appended claims. In some cases, the actions or steps described in the claims can be performed in an order different from that in the embodiments, and the desired results can still be achieved. In addition, processes described in the accompanying drawings do not necessarily need a specific order or a sequential order shown to achieve the desired results. In some implementations, multi-tasking and concurrent processing are feasible or can be advantageous.

The objectives, technical solutions, and beneficial effects of this specification have been further described in detail in the previous specific implementations. It should be understood that the previous descriptions are merely specific implementations of this specification and are not intended to limit the protection scope of this specification. Any modification, equivalent replacement, improvement, etc. made based on the technical solutions of this specification shall fall within the protection scope of this specification.

1. A computer-implemented method for updating machine learning models, comprising:
determining, by a participant of a plurality of participants, a local gradient vector based on a local sample set and current model parameters;
obtaining, by the participant, a perturbed gradient vector by performing random binarization processing on the local gradient vector based on a differential privacy algorithm;
sending, by the participant to a server, the perturbed gradient vector;
receiving, by the participant from the server, a target gradient vector determined by performing binary representation on an aggregation result of aggregating a plurality of perturbed gradient vectors received from the plurality of participants; and
updating, by the participant, the current model parameters based on the target gradient vector.

2. The computer-implemented method according to claim 1, wherein the local gradient vector comprises a first element, and performing random binarization processing on the local gradient vector comprises:
determining a first probability based on a value of the first element, wherein the first probability is positively correlated with the value of the first element; and
converting the value of the first element to 1 or −1, wherein a probability of converting the value of the first element to 1 is the first probability, and a probability of converting the value of the first element to −1 is a second probability, wherein a sum of the first probability and the second probability is 1.

3. The computer-implemented method according to claim 2, wherein determining the first probability based on the value of the first element comprises:
obtaining a second value by adding a noise value to the value of the first element; and
determining, by using a cumulative distribution function with a Gaussian distribution, the first probability based on the second value.

4. The computer-implemented method according to claim 3, wherein the noise value is obtained through random sampling from a Gaussian distribution having an expected value of 0 and a variance of σ², wherein a is determined based on a product of global sensitivity and a ratio of two differential privacy parameters.

5. The computer-implemented method according to claim 4, wherein the two differential privacy parameters comprise a privacy budget e and a relaxation term δ.

6. The computer-implemented method according to claim 3, wherein the noise value is obtained through random sampling from a Gaussian distribution having an expected value of 0 and a variance of σ², wherein a satisfies:
a difference between a third probability and a fourth probability is less than or equal to a predetermined threshold, wherein the third probability is calculated, by using the cumulative distribution function, for a maximum boundary value of a function determined based on a, and
wherein the fourth probability is calculated, by using the cumulative distribution function, for a minimum boundary value of the function determined based on σ.

7. The computer-implemented method according to claim 6, wherein the maximum boundary value is a difference between a first proportion determined based on global sensitivity and σ, and a second proportion determined based on the global sensitivity and a product of a privacy budget ε and σ, and wherein the minimum boundary value is a difference between an opposite number of the first proportion and the second proportion.

8. The computer-implemented method according to claim 1, wherein performing binary representation on the aggregation result of aggregating the plurality of perturbed gradient vectors comprises:
performing binary representation on elements in the aggregation result based on plus-minus signs of the elements by using a sign function.

9. The computer-implemented method according to claim 1, wherein the method comprises a plurality of iterations, and wherein performing binary representation on the aggregation result of aggregating the plurality of perturbed gradient vectors comprises:
superimposing an error compensation vector on the aggregation result to obtain a superimposition result, wherein the error compensation vector of a current iteration is obtained by superimposing a difference between an aggregation result of a previous iteration and a binary representation result from performing binary representation of the aggregation result in the previous iteration on an error compensation vector of the previous iteration; and
performing binary representation on elements in the superimposition result based on plus-minus signs of the elements by using a sign function.

10. A non-transitory, computer-readable medium storing one or more instructions executable by a computer system to perform operations comprising:
determining, by a participant of a plurality of participants, a local gradient vector based on a local sample set and current model parameters;
obtaining, by the participant, a perturbed gradient vector by performing random binarization processing on the local gradient vector based on a differential privacy algorithm;
sending, by the participant to a server, the perturbed gradient vector;
receiving, by the participant from the server, a target gradient vector determined by performing binary representation on an aggregation result of aggregating a plurality of perturbed gradient vectors received from the plurality of participants; and
updating, by the participant, the current model parameters based on the target gradient vector.

11. The non-transitory, computer-readable medium according to claim 10, wherein the local gradient vector comprises a first element, and performing random binarization processing on the local gradient vector comprises:
determining a first probability based on a value of the first element, wherein the first probability is positively correlated with the value of the first element; and
converting the value of the first element to 1 or −1, wherein a probability of converting the value of the first element to 1 is the first probability, and a probability of converting the value of the first element to −1 is a second probability, wherein a sum of the first probability and the second probability is 1.

12. The non-transitory, computer-readable medium according to claim 11, wherein determining the first probability based on the value of the first element comprises:
obtaining a second value by adding a noise value to the value of the first element; and
determining, by using a cumulative distribution function with a Gaussian distribution, the first probability based on the second value.

13. The non-transitory, computer-readable medium according to claim 12, wherein the noise value is obtained through random sampling from a Gaussian distribution having an expected value of 0 and a variance of σ², wherein a is determined based on a product of global sensitivity and a ratio of two differential privacy parameters.

14. The non-transitory, computer-readable medium according to claim 13, wherein the two differential privacy parameters comprise a privacy budget e and a relaxation term δ.

15. The non-transitory, computer-readable medium according to claim 12, wherein the noise value is obtained through random sampling from a Gaussian distribution having an expected value of 0 and a variance of σ², wherein σ satisfies:
a difference between a third probability and a fourth probability is less than or equal to a predetermined threshold, wherein the third probability is calculated, by using the cumulative distribution function, for a maximum boundary value of a function determined based on σ, and
wherein the fourth probability is calculated, by using the cumulative distribution function, for a minimum boundary value of the function determined based on σ.

16. The non-transitory, computer-readable medium according to claim 15, wherein the maximum boundary value is a difference between a first proportion determined based on global sensitivity and a, and a second proportion determined based on the global sensitivity and a product of a privacy budget a and a, and wherein the minimum boundary value is a difference between an opposite number of the first proportion and the second proportion.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining, by a participant of a plurality of participants, a local gradient vector based on a local sample set and current model parameters;
obtaining, by the participant, a perturbed gradient vector by performing random binarization processing on the local gradient vector based on a differential privacy algorithm;
sending, by the participant to a server, the perturbed gradient vector;
receiving, by the participant from the server, a target gradient vector determined by performing binary representation on an aggregation result of aggregating a plurality of perturbed gradient vectors received from the plurality of participants; and
updating, by the participant, the current model parameters based on the target gradient vector.

18. The computer-implemented system according to claim 17, wherein the local gradient vector comprises a first element, and performing random binarization processing on the local gradient vector comprises:
determining a first probability based on a value of the first element, wherein the first probability is positively correlated with the value of the first element; and
converting the value of the first element to 1 or −1, wherein a probability of converting the value of the first element to 1 is the first probability, and a probability of converting the value of the first element to −1 is a second probability, wherein a sum of the first probability and the second probability is 1.

19. The computer-implemented system according to claim 17, wherein performing binary representation on the aggregation result of aggregating the plurality of perturbed gradient vectors comprises:
performing binary representation on elements in the aggregation result based on plus-minus signs of the elements by using a sign function.

20. The computer-implemented system according to claim 17, wherein the one or more operations comprise a plurality of iterations, and wherein performing binary representation on the aggregation result of aggregating the plurality of perturbed gradient vectors comprises:
superimposing an error compensation vector on the aggregation result to obtain a superimposition result, wherein the error compensation vector of a current iteration is obtained by superimposing a difference between an aggregation result of a previous iteration and a binary representation result from performing binary representation of the aggregation result in the previous iteration on an error compensation vector of the previous iteration; and
performing binary representation on elements in the superimposition result based on plus-minus signs of the elements by using a sign function.
